(19) United States
(12) Patent Application Publication
(10) Pub. No.: US 2025/0368361 A1
(43) Pub. Date: Dec. 4, 2025

(54) UNMANNED AERIAL VEHICLE FOR TRAFFIC MONITORING AND MONITORING METHOD THEREFOR

(71) Applicant: Hangzhou City University Binjiang Innovation Center, Hangzhou City (CN)

(72) Inventors: Fang WANG, Hangzhou (CN); Lei WANG, Hangzhou (CN); Tiancai WU, Hangzhou (CN); Wei HONG, Hangzhou (CN); Wenqiang LIU, Hangzhou (CN)

(73) Assignee: Hangzhou City University Binjiang Innovation Center, Hangzhou City (CN)

(21) Appl. No.: 19/034,188

(22) Filed: Jan. 22, 2025

(30) Foreign Application Priority Data
May 31, 2024 (CN) 202410699249.X

(51) Int. Cl. B64U 20/87; B61L 23/04; B64U 10/10; B64U 101/31; H04N 7/18

(52) U.S. Cl. CPC B64U 20/87; B61L 23/04; B64U 10/10; H04N 7/185; B64U 2101/31

(57) ABSTRACT

An unmanned aerial vehicle for traffic monitoring and a monitoring method are provided. The unmanned aerial vehicle for traffic monitoring includes a main body connected with multiple legs, and multiple regulating mechanisms are installed on the legs. Each fixed rod is rotatably connected to a wing, and a surface of the wing is coated with absorbing material. A chuck is obliquely installed at one end of each wing, and multiple bumps are installed on the chuck. Driving mechanisms are installed on a labeling mechanism and fixed rods. A first driving mechanism includes a box, the box is installed on each fixed rod, and a hydraulic rod for driving a first toothed plate to move up and down and is installed on the top of the box. The first toothed plate is meshed with a gear, and a notch is formed at the middle of the first toothed plate.

### CROSS-REFERENCE TO RELATED APPLICATION

This patent application claims the benefit and priority of Chinese Patent Application No. 202410699249.X filed with the China National Intellectual Property Administration on May 31, 2024, the disclosure of which is incorporated by reference herein in its entirety as part of the present application.

### TECHNICAL FIELD

The present disclosure relates to the technical field of traffic monitoring, in particular to an unmanned aerial vehicle for traffic monitoring and a monitoring method for the unmanned aerial vehicle for traffic monitoring.

### BACKGROUND

Traditional railway monitoring needs a lot of manpower, material resources and time investment, and the manpower and operation costs may be saved for railway monitoring with unmanned aerial vehicles. The railway may be monitored by the unmanned aerial vehicle during the operational period without being stopped or slowed down, and the speed and lifting height of the unmanned aerial vehicle are adjustable, so that the monitoring area is increased, and the time and cost of railway monitoring are reduced. Then, through a sensor equipment, the unmanned aerial vehicle may provide high-definition images and accurate data information which may be analyzed through playback, so that railway problems are effectively discovered, and at the same time, the manpower is saved.

When the railway is monitored by the unmanned aerial vehicle, the high-speed train may generate strong airflow and strong electromagnetic field interference when passing through the railway, so the remote-control signal and airborne circuit are easily interfered by the strong electromagnetic field, the quality of captured images are poor, and the monitoring quality of the unmanned aerial vehicle to the railway is reduced. At the same time, the airflow may also interfere with the movement of the unmanned aerial vehicle, and even cause the unmanned aerial vehicle to fall on the track, so that the train operation and safety are affected.

Therefore, it is necessary to provide a novel unmanned aerial vehicle for traffic monitoring and a monitoring method for the unmanned aerial vehicle for traffic monitoring to solve the above-mentioned technical problems.

### SUMMARY

The technical problem solved by the present disclosure is to provide an unmanned aerial vehicle for traffic monitoring and a monitoring of the unmanned aerial vehicle for traffic monitoring, by which the inference of high-speed railways on unmanned aerial vehicles is reduced, and the flight stability of the unmanned aerial vehicle is increased.

In order to solve the above-mentioned technical problem, an unmanned aerial vehicle for traffic monitoring includes a main body, a plurality of legs being installed on side walls of the main body and configured for supporting the main body, and a plurality of regulating mechanisms being installed on side walls of the legs and configured for increasing flight stability of the main body, wherein each regulating mechanism comprises a fixed rod fixedly connected to side walls of corresponding legs, a side wall of the fixed rod is rotatably connected to a wing with a fusiform cross section, and a surface of the wing is coated with an absorbing material; a chuck is obliquely installed at one end of each wing and is configured for clearing sundries, and a plurality of bumps are installed on a side wall of the chuck and are configured for increasing a frictional force of the chuck; a labeling mechanism is installed on the side wall of the main body and is configured for labeling positions with potential safety hazards of railways, a plurality of driving mechanisms are installed on side walls of the labeling mechanism and fixed rods, respectively, a first driving mechanism comprises a first box, a first box is installed on the side wall of each fixed rod, and a first hydraulic rod is installed on the top of the first box and is configured for driving a first toothed plate to move up and down; the first toothed plate is meshed with a first gear, and a notch is formed at a middle of a side wall of the first toothed plate; a side wall of the wing is fixedly connected to a first rotating shaft fixedly connected to the first gear; and a torsional spring sleeves a side wall of the first rotating shaft, and two ends of the torsional spring are connected to side walls of the first rotating shaft and the first box, respectively.

In some embodiments, the main body comprises an aircraft body, the plurality of legs are symmetrically and obliquely installed on the side walls of the aircraft body, and a plurality of aircraft arms are symmetrically installed on the side walls of the main body; and a driving motor is installed at one end of each aircraft arm, and rotor wings are installed on a top of the driving motor.

In some embodiments, the labeling mechanism comprises a fixed tube provided at a bottom of the aircraft body, barrels are symmetrically installed on the side walls of the aircraft body, and bottommost ends of the barrels are in communication with an interior of the fixed tube through connecting hoses; and a motor for driving a blade to rotate is installed on a top of the fixed tube, and a nozzle is installed at a bottom of the fixed tube.

In some embodiments, the labeling mechanism further comprises a fixed block, the fixed block and a blocking rod are installed inside the fixed tube, a piston is clamped in the fixed block, and a spring is installed between the blocking rod and the piston; a first magnetic ring is installed on a surface of the piston, a second magnetic ring is installed inside the fixed block, and the first magnetic ring and the second magnetic ring are adsorbed with each other.

In some embodiments, interiors of the fixed tube and the fixed block are in a funnel shape, and the blade is in a spiral shape and is rotatably connected to and inside the fixed tube.

In some embodiments, t a second driving mechanism comprises a second rotating shaft and a second toothed plate, the second rotating shaft is rotatably connected to the bottom of the aircraft body, and the fixed tube is fixedly connected to a middle of a side wall of the second rotating shaft; a second box is installed to the bottom of the aircraft body, the second toothed plate is slidably connected to and inside the second box, and the second toothed plate is connected to a second hydraulic rod; and the second toothed plate is meshed with the gear, and the gear is fixedly connected to the second rotating shaft.

In some embodiments, two ends of the second rotating shaft are fixedly connected to high-definition cameras, the high-definition cameras are inclined towards the fixed tube, and an infrared camera is installed at the bottom of the aircraft body.

In some embodiments, fixture blocks are symmetrically installed on side walls of the aircraft body, a side wall of each fixture block is fixedly connected to an elastic leaf spring with an arc-shaped side wall, and the side wall of the wing is clamped by the leaf spring.

In some embodiments, a monitoring method for the unmanned aerial vehicle for traffic monitoring specifically includes the following steps:
in step one, when a high-speed railway is monitored, controlling, by an operating handle of the unmanned aerial vehicle, a communication module inside the main body to connect with a central processing unit inside the main body, operating the central processing unit to turn on a flight module to turn on the driving motors, the driving motors driving the rotor wings to rotate so that the main body flies, the flight module altering relative rotating speeds among the rotor wings by controlling rotating speeds of the driving motors, such that a magnitude of uniaxial propelling force is changed, and a moving trajectory of the main body is controlled; capturing images by the high-definition cameras and the infrared camera at a bottom of the main body, and a video storage processing module transmitting the captured images to the operating handle of the unmanned aerial vehicle through the communication module, so that the high-speed railway is convenient for people to monitor;
in step two, during the monitoring process, the capturing distance of the infrared camera being long, capturing long-range images, when it is observed that garbage is wrapped around an overhead line system of the high-speed railway, the main body flying to a place where the garbage is wrapped, images of the high-definition cameras being clear, the place where the garbage is wrapped being seen clearly through the high-definition cameras, at this time, the main body being located above the garbage, turning on first hydraulic rods, the first hydraulic rods driving first toothed plates to move downwards so as to push the wings to rotate downwards, making a distance between two wings closer and closer so that chucks at ends of the wings get close to clamp the garbage, increasing the frictional force through the bumps on the side walls of the chucks to avoid the garbage from sliding off, controlling a flight of the main body to pull off the garbage from a surface of the overhead line system by the main body, the wings and the chucks, in this process, operating the second hydraulic rod on the side wall of the second rotating shaft to drive the high-definition cameras to rotate so that a process that the garbage is cleared by the chucks is captured by the high-definition cameras clearly, which is convenient for people to operate, and avoids the main body from making direct contact with the overhead line system;
in step three, when the high-speed railway takes two minutes to reach the main body, transmitting train operation information to the operating handle and the central processing unit of the unmanned aerial vehicle through a high-speed railway operation platform, at this time, operating the main body to fly upwards so that the distance between the main body and the railway is over 10 meters, operating a flight balance module to control operations of the first hydraulic rods on the side walls of the fixed rods to push the wings to open by the first hydraulic rods, so as to increase the stability of the main body, and at the same time, regulating angles and positions of the wings on both sides of the main body by the flight balance module by controlling the first hydraulic rods, so that the stability of the main body is further increased to avoid airflow generated by high-speed railway operation from interfering the flight of the main body;
in step four, when the overhead line system, the railway, protective screenings and other objects are monitored at short distances, operating the flight balance module to control the operations of the first hydraulic rods to regulate positions of the wings, so that the flight stability of the main body is increased; especially, when the overhead line system is monitored by the main body, the operation of the aircraft body is affected by a magnetic field generated by the current conveyed by the overhead line system, surfaces of the wings are coated with the absorbing material, and the absorbing material reduces the influence of electromagnetic energy around the main body on the main body, so that the operational stability of the main body is increased; when a safe failure appears in the monitoring process, spraying out labeling paint by the labeling mechanism at the bottom of the main body and at a failure position on the railway to facilitate workers to observe the failure position, at the same time, transmitting coordinates of the failure position on the railway to the operating handle of the unmanned aerial vehicle by a positioning module to facilitate worker processing; and
in step five, when the main body needs to descend, operating the central processing unit to drive the operations of the first hydraulic rods on the side walls of the fixed rods, to drive the operations of the first toothed plates to make notches being aligned with respective gears, such that the wings are not restrained and move downwards under an effect of torsional springs, and the wings and the chucks are obliquely located below the legs, when the main body falls to the ground gradually, the chucks make contact with the ground, along with a falling of the main body, under an effect of gravity, the chucks and the wings move upwards gradually, the torsional springs rotate strongly, and at the same time, a falling speed of the main body is decreased by the torsional springs so that the main body falls down smoothly.

Compared with the prior art, the unmanned aerial vehicle for traffic monitoring and the monitoring method for the unmanned aerial vehicle for traffic monitoring provided by the present disclosure has the following beneficial effects.

According to the unmanned aerial vehicle for traffic monitoring and the monitoring method for the unmanned aerial vehicle for traffic monitoring provided by the present disclosure, when it is observed that garbage is wrapped around an overhead line system of a high-speed railway, the main body flies to the place where garbage is wrapped. The images of the high-definition cameras are clear. The place where garbage is wrapped may be seen clearly through the high-definition cameras. At this time, the main body is located above the garbage. The first hydraulic rods are turned on. The first hydraulic rods drive the first toothed plates to move downwards so as to push the wings to rotate downwards. The distance between the two wings becomes closer and closer so that the chucks at one end of the wings get close to clamp the garbage. The frictional force is increased through the bumps on the side walls of the chucks to avoid the garbage from sliding off. The flight of the main body is controlled so that the garbage is pulled off from the surface of the overhead line system by the main body, the wings and the chucks. At the moment that the high-speed railway takes two minutes to reach the main body, train operation information is transmitted to the operating handle of the unmanned aerial vehicle and the central processing unit through a high-speed railway operation platform. At this time, the main body is controlled to fly upwards so that the distance between the main body and the railway is over 10 meters. At this time, the operation of a flight balance module controls the operation of the first hydraulic rods on the side walls of the fixed rods. The wings are pushed to open by the first hydraulic rods to increase the stability of the main body. At the same time, the angles and positions of the wings on both sides of the main body are regulated by the flight balance module by controlling the first hydraulic rods, so that the stability of the main body is further increased to avoid airflow generated by high-speed railway operation from interfering the flight of the main body. When the main body needs to descend, the operations of the first hydraulic rods drives the first toothed plates to move so that the notches are aligned with respective gears. The wings are not restrained and move downwards under the effect of the torsional springs so that the wings and the chucks are obliquely located below the legs. When the main body falls to the ground gradually, the chucks make contact with the ground. Along with the falling of the main body, under the effect of gravity, the chucks and the wings move upwards gradually, and the torsional springs rotate strongly. At the same time, the falling speed of the main body is decreased by the torsional springs so that the main body falls down smoothly.

### BRIEF DESCRIPTION OF THE DRAWINGS

FIG. 1 is a structural schematic diagram of an unmanned aerial vehicle for traffic monitoring and a monitoring method for the unmanned aerial vehicle for traffic monitoring according to the present disclosure.

FIG. 2 is an enlarged schematic diagram of the structure of part A as shown in FIG. 1.

FIG. 3 is a structural schematic diagram of the interior of a fixed tube as shown in FIG. 2.

FIG. 4 is a side view of the structure of an aircraft body as shown in FIG. 1.

FIG. 5 is a top view of the structure of a wing as shown in FIG. 4.

FIG. 6 is a top view of the structure of an aircraft body as shown in FIG. 1.

FIG. 7 is a structural schematic diagram of closed chucks as shown in FIG. 4.

FIG. 8 is a structural schematic diagram of an aircraft body in a falling state as shown in FIG. 1.

FIG. 9 is a structural schematic diagram of the interior of a box as shown in FIG. 4.

FIG. 10 is a structural schematic diagram of a first rotating shaft as shown in FIG. 10.

FIG. 11 is a structural schematic diagram of the interior of a box as shown in FIG. 2.

FIG. 12 is a structural schematic diagram of a circuit according to the present disclosure.

Reference signs: 1, leg; 2, main body; 21, aircraft body; 22, aircraft arm; 23, driving motor; 24, rotor wing; 25, high-definition camera; 26, infrared camera; 3, labeling mechanism; 31, fixed tube; 32, motor; 33, connecting hose; 34, blade; 35, fixed block; 36, piston; 37, spring; 38, blocking rod; 39, first magnetic ring; 310, second magnetic ring; 311, barrel; 312, nozzle; 4, regulating mechanism; 41, wing; 42, fixed rod; 43, chuck; 44, bump; 45, fixture block; 46, leaf spring; 47, absorbing material; 5, driving mechanism; 51, hydraulic rod; 52, box; 53, first toothed plate; 54, notch; 55, gear; 56, first rotating shaft; 57, second rotating shaft; 58, second toothed plate; and 59, torsional spring.

### DETAILED DESCRIPTION OF THE EMBODIMENTS

The description of the present disclosure is further described in conjunction with the attached figures and embodiments.

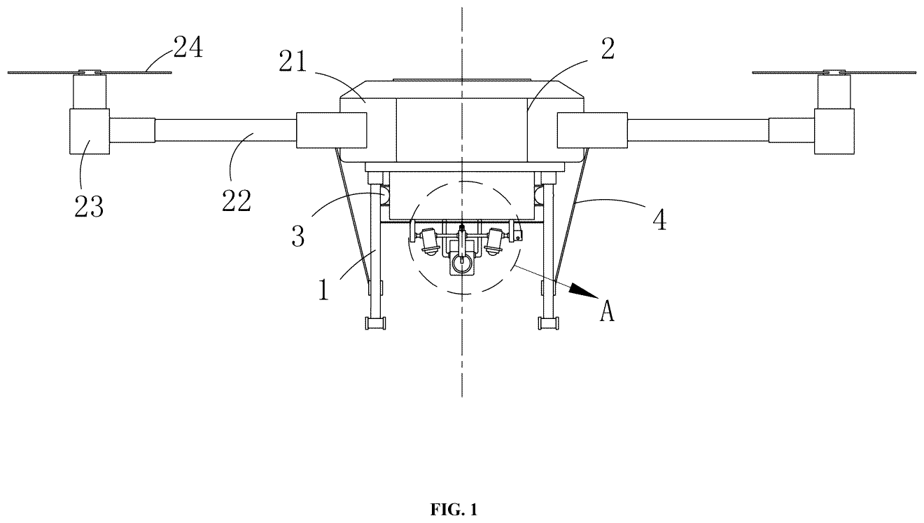

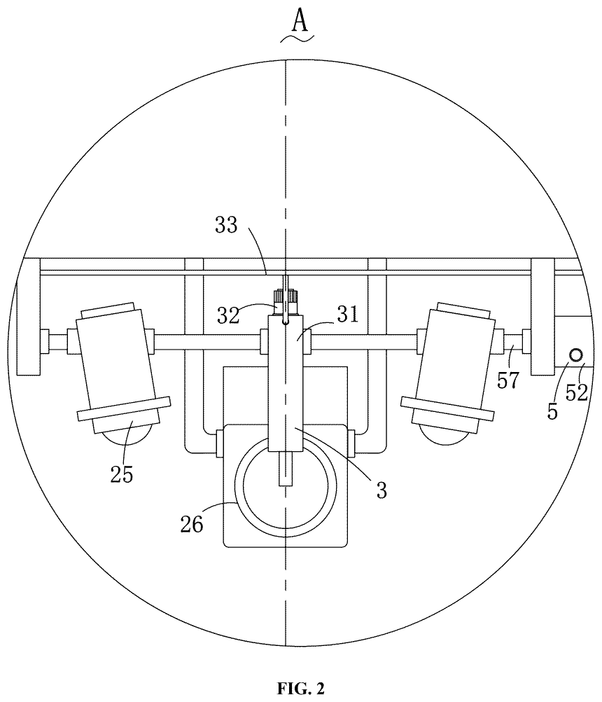

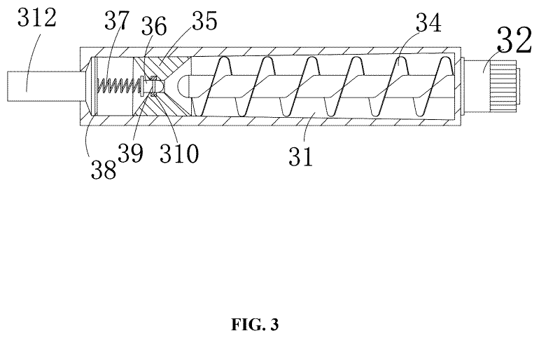

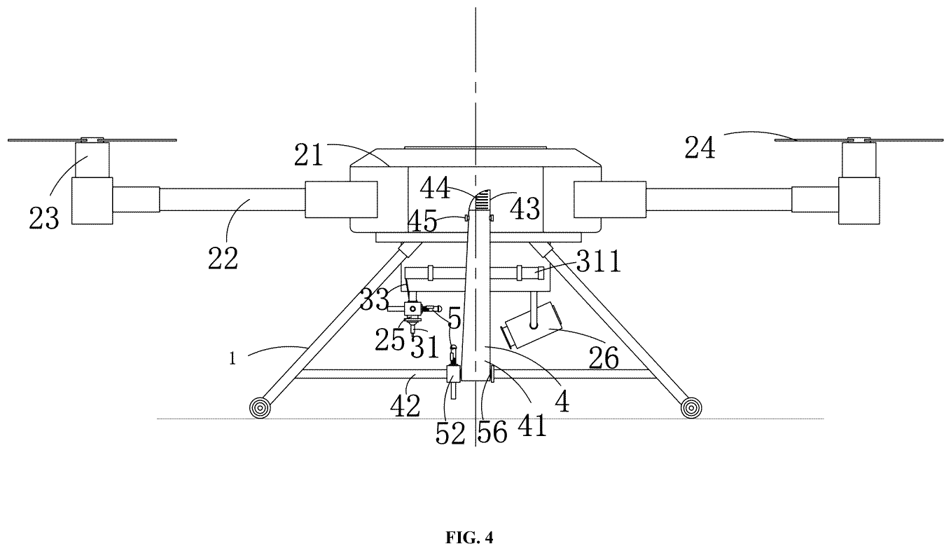

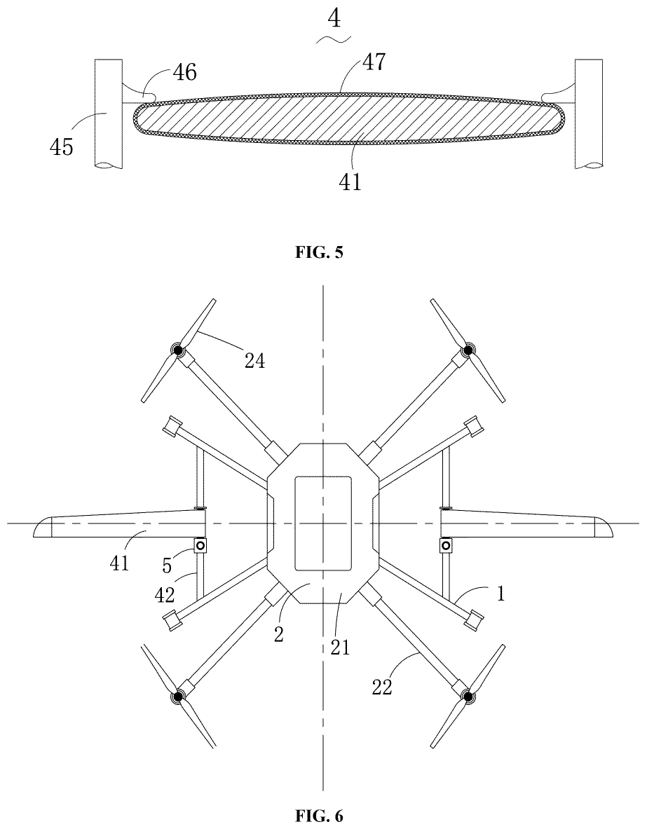

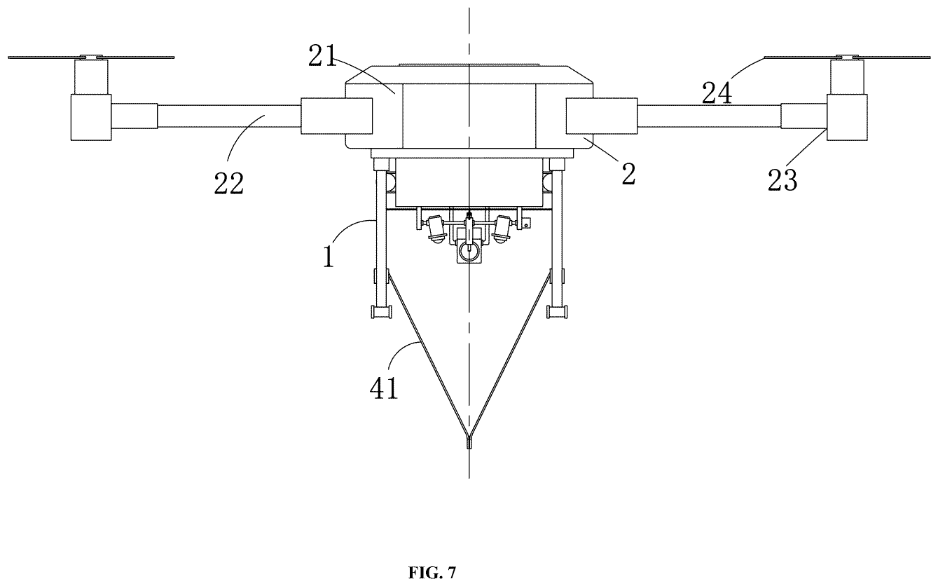

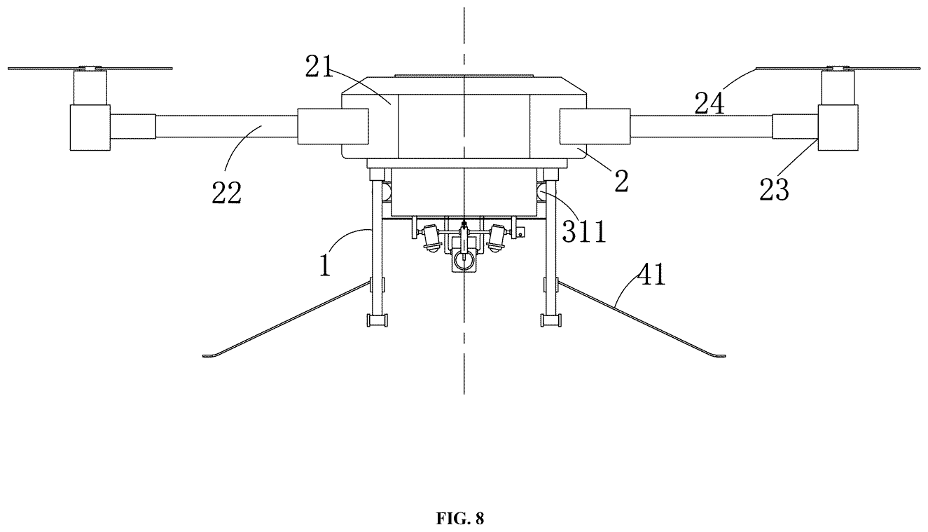

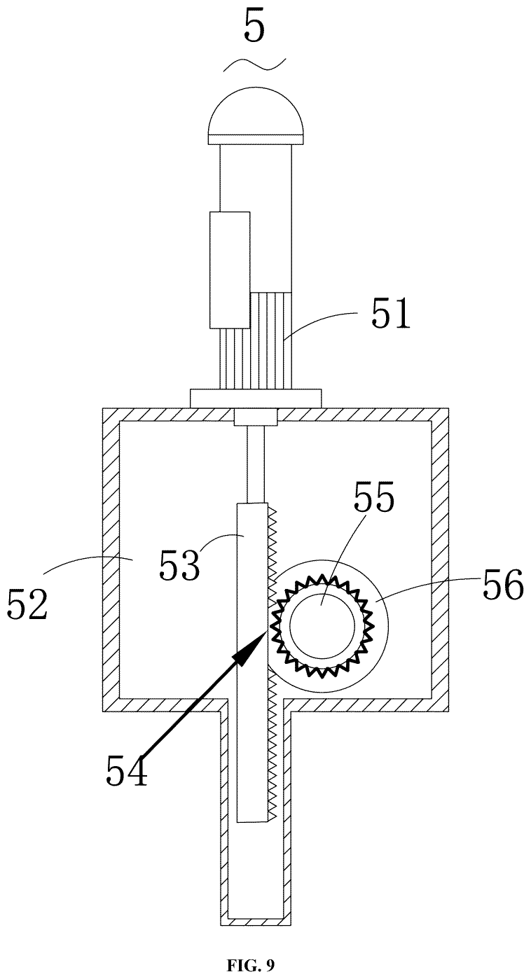

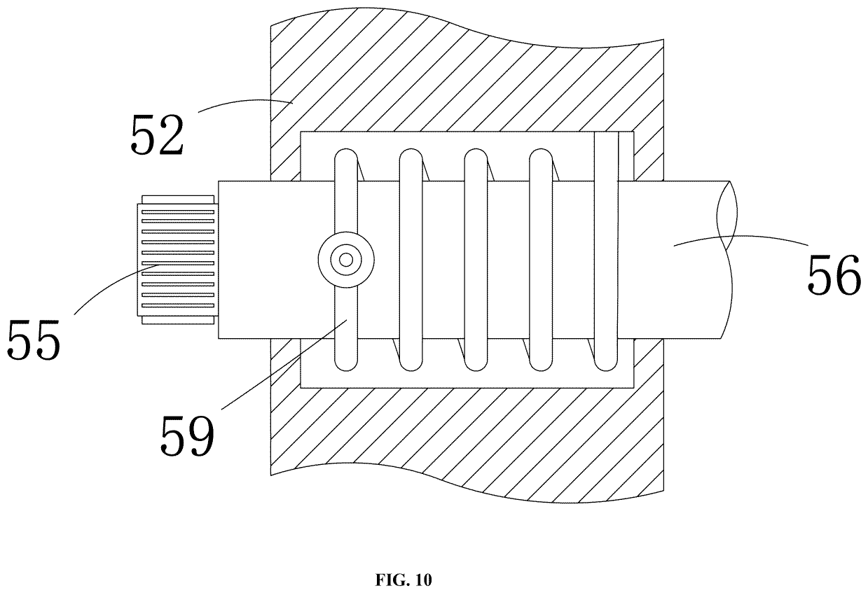

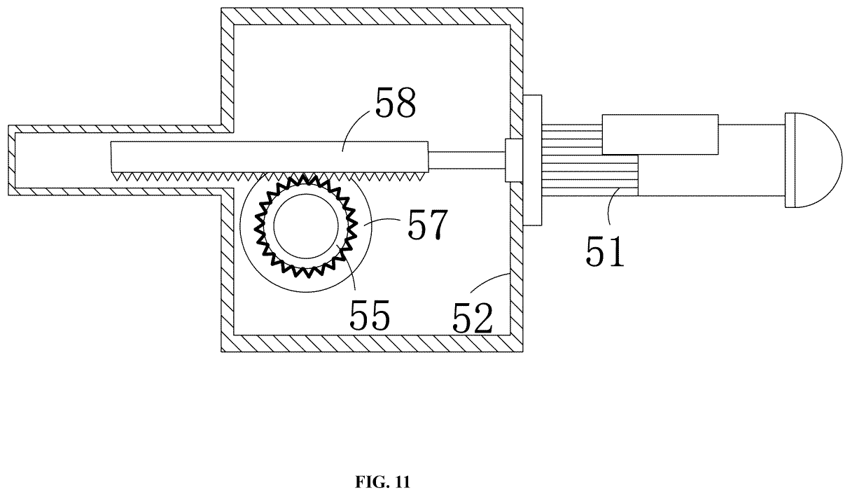

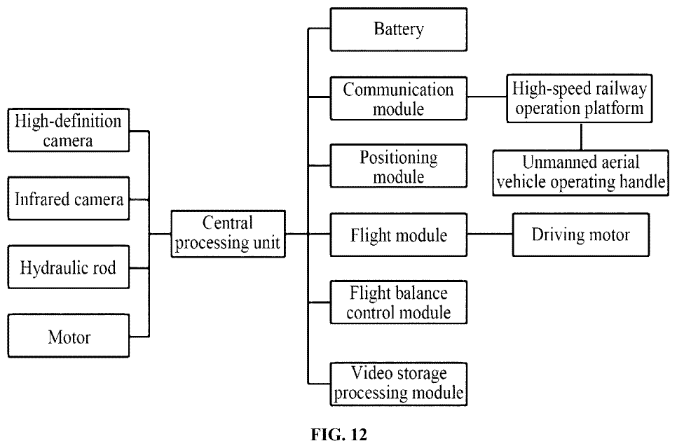

Referring to FIG. 1 to FIG. 12, FIG. 1 is a structural schematic diagram of an unmanned aerial vehicle for traffic monitoring and a monitoring method for the unmanned aerial vehicle for traffic monitoring provided by the present disclosure. FIG. 2 is an enlarged schematic diagram of the structure of part A as shown in FIG. 1. FIG. 3 is a structural schematic diagram of the interior of a fixed tube as shown in FIG. 2. FIG. 4 is a side view of the structure of an aircraft body as shown in FIG. 1. FIG. 5 is a top view of the structure of a wing as shown in FIG. 4. FIG. 6 is a top view of the structure of an aircraft body as shown in FIG. 1. FIG. 7 is a structural schematic diagram of closed chucks as shown in FIG. 4. FIG. 8 is a structural schematic diagram of an aircraft body in a falling state as shown in FIG. 1. FIG. 9 is a structural schematic diagram of the interior of a box as shown in FIG. 4. FIG. 10 is a structural schematic diagram of a first rotating shaft as shown in FIG. 10. FIG. 11 is a structural schematic diagram of the interior of a box as shown in FIG. 2. FIG. 12 is a structural schematic diagram of a circuit provided by the present disclosure. Wherein, the unmanned aerial vehicle for traffic monitoring includes a main body 2. Legs 1 for supporting the main body 2 are installed on side walls of the main body 2. The main body 2 includes an aircraft body 21. The legs 1 are symmetrically and obliquely installed on side walls of the aircraft body 21. Multiple aircraft arms 22 are symmetrically installed on the side walls of the main body 2. A driving motor 23 is installed at one end of each aircraft arm 22, and rotor wings 24 are installed on the top of each driving motor 23. When a high-speed railway is monitored, a communication module inside the main body 1 is controlled to be connected with a central processing unit inside the main body 1 by an operating handle of the unmanned aerial vehicle. The operation of the central processing unit is controlled to turn on a flight module. The flight module turns on the driving motors 23. The driving motors 23 drive the rotor wings 24 to rotate so that the main body 2 flies. The flight module changes the relative rotating speeds among the different rotor wings 24 by controlling the rotating speeds of the driving motors 23. The magnitude of uniaxial propelling force may be changed, so that the moving trajectory of the main body 2 is controlled.

Regulating mechanisms 4 for increasing the flight stability of the main body 2 are installed on side walls of the corresponding legs 1. Each regulating mechanism 4 includes a fixed rod 42 fixedly connected to the side walls of the corresponding legs 1. A side wall of the fixed rod 42 is rotatably connected to a wing 41 with a fusiform cross section. The resistance when the wings 41 fly are reduced by the fusiform wings 41. A surface of each wing 41 is coated with absorbing material 47. A chuck 43 for clearing sundries is obliquely installed at one end of each wing 41, and multiple bumps 44 for increasing the frictional force of the chuck 43 are installed on a side wall of the chuck 43. When it is observed that garbage is wrapped around an overhead line system of a high-speed railway, the main body 2 flies to the place where garbage is wrapped. The images of the high-definition cameras 25 are clear. The place where garbage is wrapped may be seen clearly through the high-definition cameras 25. At this time, the main body 2 is located above the garbage. The hydraulic rods 51 are turned on. The hydraulic rods 51 drive the first toothed plates 53 to move downwards so as to push the wings 41 to rotate downwards. The distance between the two wings 41 becomes closer and closer so that the chucks 43 at ends of the wings 41 get close to clamp the garbage. The frictional force is increased through the bumps 44 on the side walls of the chucks 43 to avoid the garbage from sliding off. The flight of the main body 2 is controlled so that the garbage is pulled off from the surface of the overhead line system by the main body 2, the wings 41 and the chucks 43. When the main body 2 flies, the hydraulic rods 51 on the side walls of the fixed rods 42 operate. The wings 41 are pushed to open by the hydraulic rods 51 to increase the stability of the main body 2. At the same time, the angles and positions of the wings 41 on both sides of the main body 2 are regulated by the flight balance module by controlling the hydraulic rods 51, so that the stability of the main body 2 is further increased to avoid airflow generated by high-speed railway operation from interfering the flight of the main body 2.

Another driving mechanism 5 includes a second rotating shaft 57 and a second toothed plate 58. The bottom of the aircraft body 21 is rotatably connected to the second rotating shaft 57. The fixed tube 31 is fixedly connected to the middle of a side wall of the second rotating shaft 57. Another box 52 is installed at the bottom of the aircraft body 21. The interior of the box 52 is slidably connected to the second toothed plate 58. The second toothed plate 58 is connected to the hydraulic rod 51. The second toothed plate 58 is meshed with the gear 55, and the gear 55 is fixedly connected to the second rotating shaft 57. Both ends of the second rotating shaft 57 are fixedly connected to high-definition cameras 25. An infrared camera 26 is installed at the bottom of the aircraft body 21. In the flight process, the operation of the hydraulic rod 51 on the side wall of the second rotating shaft 57 drives the high-definition cameras 25 to move. The second toothed plate 58 drives the gear 55, the second rotating shaft 57, the high-definition cameras 25 and the fixed tube 31 to rotate, so that the capturing range of the high-definition camera 25 is increased, and a failure place for the railway is captured by the high-definition cameras 25 conveniently. At the same time, the high-definition cameras 25 are inclined towards the direction of the fixed tube 31, so that images around the fixed tube 31 are captured by the high-definition cameras 25 to judge whether the fixed tube 31 is aligned to the failure place for the railway, and thus paint is accurately sprayed to the failure place for the railway.

A labeling mechanism 3 for labeling places with potential safety hazards for railways is installed on the side wall of the main body 2. The labeling mechanism 3 includes a fixed tube 31. The bottom of the aircraft body 21 is provided with the fixed tube 31. Barrels 311 are symmetrically installed on side walls of the aircraft body 21. The bottommost ends of the barrels 311 are in communication with the interior of the fixed tube 31 through connecting hoses 33. A motor 32 for driving a blade 34 to rotate is installed on the top of the fixed tube 31. A nozzle 312 is installed at the bottom of the fixed tube 31. The labeling mechanism 3 further includes a fixed block 35. The fixed block 35 and a blocking rod 38 are installed inside the fixed tube 31. A piston 36 is clamped in the fixed block 35. A spring 37 is installed between the blocking rod 38 and the piston 36. A first magnetic ring 39 is installed on a surface of the piston 36. A second magnetic ring 310 is installed inside the fixed block 35. The first magnetic ring 39 and the second magnetic ring 310 are adsorbed with each other. The interiors of the fixed tube 31 and the fixed block 35 are in a funnel shape, and the interior of the fixed tube 31 is rotatably connected to the spiral blade 34. When the failure place for the railway is labeled, the nozzle 312 is aligned to the position. The operation of the motor 32 pushes the spiral blade 34 to rotate inside the fixed tube 31 clockwise. The paint inside the fixed tube 31 is extruded to move towards the fixed block 35. The paint inside the barrels 311 enters into the interior of the fixed tube 31 through the connecting hoses 33. Along with the rotation of the blade 34 inside the funnel-shaped fixed tube 31, the extrusion force of the paint for the piston 36 inside the fixed block 35 becomes larger and larger. When the extrusion force is larger than the resistance, the piston 36 slides out from the inside of the fixed block 35 to extrude the spring 37. At the same time, the first magnetic ring 39 on the side wall of the piston 36 is separated from the second magnetic ring 310 inside the fixed block 35. The resistance of the piston 36 sliding out of the inside of the fixed block 35 is decreased suddenly. The piston 36 slides out of the inside of the fixed block 35 quickly. At this time, the extruded paint inside the fixed tube 31 is sprayed out from the inside of the nozzle 312 to the failure place for the railway. When labeling is stopped, the motor 32 stops rotating, and the spring 37 pushes the piston 36 to reset so as to close the fixed block 35.

Driving mechanisms 5 are installed on side walls of the labeling mechanism 3 and the fixed rods 42, respectively. Each driving mechanism 5 includes a box 52. The box 52 is installed on the side wall of the fixed rod 42. A hydraulic rod 51 for driving a first toothed plate 53 to move up and down is installed on the top of the box 52. The first toothed plate 53 is meshed with a gear 55, and a notch 54 is formed at the middle of a side wall of the first toothed plate 53. A side wall of the wing 41 is fixedly connected to a first rotating shaft 56, and the first rotating shaft 56 and the gear 55 are fixedly connected. A torsional spring 59 sleeves a side wall of the first rotating shaft 56, and both ends of the torsional spring 59 are connected to side walls of the first rotating shaft 56 and the box 52, respectively. When the main body 2 needs to descend, the operation of the central processing unit drives the operations of the hydraulic rods 51 on the side walls of the fixed rods 42. The operations of the first toothed plates 53 are driven so that the notches 54 are aligned with respective gears 56. The wings 41 are not restrained and move downwards under the effect of torsional springs 59 so that the wings 41 and the chucks 43 are obliquely located below the legs 1. When the main body 2 falls to the ground gradually, the chucks 43 make contact with the ground. Along with the falling of the main body 2, under the effect of gravity, the chucks 43 and the wings 41 move upwards gradually. The torsional springs 59 rotate strongly. At the same time, the falling speed of the main body 2 is decreased by the torsional springs 59 so that the main body 2 falls down smoothly.

Fixture blocks 45 are symmetrically installed on side walls of the aircraft body 21. A side wall of each fixture block 45 is fixedly connected to an elastic leaf spring 46 with an arc-shaped side wall. The side wall of the wing 41 is clamped by the leaf spring 46. When the wings 41 need to be folded, the first rotating shafts 56 rotate so that the wings 41 enter the middle of the fixture blocks 45. The wings 41 extrude the leaf springs 46 with an arc-shaped side wall so that the leaf springs 46 deform to enter the middle of the fixture blocks 45. The leaf springs 46 are reset to clamp the side walls of the wings 41 after being separated from the wings 41. Each wing 41 is fixed between the two fixture blocks 45 to avoid the wing 41 from shaking at random.

A monitoring method for the unmanned aerial vehicle for traffic monitoring specifically includes the following steps.

In step one, when a high-speed railway is monitored, a communication module inside the main body 1 is controlled to be connected with a central processing unit inside the main body 1 by an operating handle of an unmanned aerial vehicle. The operation of the central processing unit is controlled to turn on a power supply and a flight module. Power is supplied for an incoming line of the power supply. The flight module turns on the driving motors 23. The driving motors 23 drive the rotor wings 24 to rotate so that the main body 2 flies. The flight module changes the relative rotating speeds among the different rotor wings 24 by controlling the rotating speeds of the driving motors 23. The magnitude of uniaxial propelling force may be changed, so that the moving trajectory of the main body 2 is controlled. Images are captured by the high-definition cameras 25 and the infrared camera 26 at the bottom of the main body 2, and the captured images are transmitted to the operating handle of the unmanned aerial vehicle through the communication module by a video storage processing module, so that the high-speed railway is convenient for people to monitor.

In step two, during the monitoring process, the capturing distance of the infrared camera 26 is long, and long-range images are captured. When it is observed that garbage is wrapped around an overhead line system of a high-speed railway, the main body 2 flies to the place where garbage is wrapped. The images of the high-definition cameras 25 are clear. The place where garbage is wrapped may be seen clearly through the high-definition cameras 25. At this time, the main body 2 is located above the garbage. The hydraulic rods 51 are turned on. The hydraulic rods 51 drive the first toothed plates 53 to move downwards so as to push the wings 41 to rotate downwards. The distance between the two wings 41 becomes closer and closer so that the chucks 43 at ends of the wings 41 get close to clamp the garbage. The frictional force is increased through the bumps 44 on the side walls of the chucks 43 to avoid the garbage from sliding off. The flight of the main body 2 is controlled so that the garbage is pulled off from the surface of the overhead line system by the main body 2, the wings 41 and the chucks 43. In this process, the operation of the hydraulic rod 51 on the side wall of the second rotating shaft 57 drives the high-definition cameras 25 to rotate so that the process that the garbage is cleared by the chucks 43 is captured by the high-definition cameras 25 clearly. The unmanned aerial vehicle is convenient for people to operate, and the main body 2 is avoided from making direct contact with the overhead line system.

In step three, when the high-speed railway takes two minutes to reach the main body 2, train operation information is transmitted to the operating handle of the unmanned aerial vehicle and the central processing unit by a high-speed railway operation platform. At this time, the main body 2 is controlled to fly upwards so that the distance between the main body 2 and the railway is over 10 meters. At this time, the operation of a flight balance module controls the operation of the hydraulic rods 51 on the side walls of the fixed rods 42 to push the wings 41 to open by the hydraulic rods 51, so as to increase the stability of the main body 2. At the same time, the angles and positions of the wings 41 on both sides of the main body 2 are regulated by the flight balance module by controlling the hydraulic rods 51, so that the stability of the main body 2 is further increased to avoid airflow generated by high-speed railway operation from interfering the flight of the main body 2.

In step four, when the overhead line system, the railway, protective screenings and other objects are monitored at short distances, the operation of the flight balance module controls the operations of the hydraulic rods 51 to regulate the positions of the wings 41, and the flight stability of the main body 2 is increased. Especially, when the overhead line system is monitored by the main body 2, the operation of the aircraft body 21 is affected by a magnetic field generated by the current conveyed by the overhead line system. The surfaces of the wings 41 are coated with the absorbing material 47. The absorbing material 47 reduces the influence of electromagnetic energy around the main body 2 on the main body 2, so that the operational stability of the main body 2 is increased. During the monitoring process, the operation of the central processing unit turns on the hydraulic rod 51 on the side wall of the second rotating shaft 57, so that the hydraulic rod 51 drives the second toothed plate 58 to move. The second toothed plate 58 drives the gear 55, the second rotating shaft 57, the high-definition cameras 25 and the fixed tube 31 to rotate, so that the capturing range of the high-definition cameras 25 is increased, and a failure place for the railway is captured by the high-definition cameras 25 conveniently. At the same time, the high-definition cameras 25 are inclined towards the direction of the fixed tube 31, so that images around the fixed tube 31 are captured by the high-definition cameras 25 to judge whether the fixed tube 31 is aligned to the failure place for the railway. The nozzles 312 are aligned to the position. The operation of the motor 32 pushes the spiral blade 34 to rotate inside the fixed tube 31 clockwise. The paint inside the fixed tube 31 is extruded to move towards the fixed block 35. The paint inside the barrels 311 enters into the interior of the fixed tube 31 through the connecting hoses 33. Along with the rotation of the blade 34 inside the funnel-shaped fixed tube 31, the extrusion force of the paint for the piston 36 inside the fixed block 35 becomes larger and larger. When the extrusion force is larger than the resistance, the piston 36 slides out of the inside of the fixed block 35 to extrude the spring 37. At the same time, the first magnetic ring 39 on the side wall of the piston 36 is separated from the second magnetic ring 310 inside the fixed block 35. The resistance of the piston 36 sliding out of the inside of the fixed block 35 is decreased suddenly. The piston 36 slides out of the inside of the fixed block 35 quickly. At this time, the extruded paint inside the fixed tube 31 is sprayed out of the inside of the nozzle 312 to the failure place for the railway to avoid the paint from scattering, so that the paint is smeared at the position of the safe failure on the railway to facilitate workers to observe the position of the failure. At the same time, coordinates of the position of safe failure on the railway are transmitted to the operating handle of the unmanned aerial vehicle by a positioning module to facilitate worker processing.

In step five, when the main body 2 needs to descend, the operation of the central processing unit drives the operations of the hydraulic rods 51 on the side walls of the fixed rods 42. The operations of the first toothed plates 53 are driven so that the notches 54 are aligned to the respective gears 56. The wings 41 are not restrained and move downwards under the effect of the torsional springs 59 so that the wings 41 and the chucks 43 are obliquely located below the legs 1. When the main body 2 falls to the ground gradually, the chucks 43 make contact with the ground. Along with the falling of the main body 2, under the effect of gravity, the chucks 43 and the wings 41 move upwards gradually. The torsional springs 59 rotate strongly. At the same time, the falling speed of the main body 2 is decreased by the torsional springs 59 so that the main body 2 falls down smoothly.

The above are only the embodiments of the present disclosure and not intended to limit the patent scope of the present disclosure, and any equivalent structures or equivalent flow transformations based on the specification and the attached figures of the present disclosure, which is directly or indirectly applied in other related technical fields, shall similarly fall within the scope of patent protection of the present disclosure.

What is claimed is:

1. An unmanned aerial vehicle for traffic monitoring, comprising:
a main body (2), a plurality of legs (1) being installed on side walls of the main body (2) and configured for supporting the main body (2), and a plurality of regulating mechanisms (4) being installed on side walls of the legs (1) and configured for increasing flight stability of the main body (2), wherein each regulating mechanism (4) comprises a fixed rod (42) fixedly connected to side walls of corresponding legs (1), a side wall of the fixed rod (42) is rotatably connected to a wing (41) with a fusiform cross section, and a surface of the wing (41) is coated with an absorbing material (47); a chuck (43) is obliquely installed at one end of each wing (41) and is configured for clearing sundries, and a plurality of bumps (44) are installed on a side wall of the chuck (43) and are configured for increasing a frictional force of the chuck (43);
a labeling mechanism (3) is installed on the side wall of the main body (2) and is configured for labeling positions with potential safety hazards of railways, a plurality of driving mechanisms (5) are installed on side walls of the labeling mechanism (3) and fixed rods (42), respectively, a first driving mechanism (5) comprises a first box (52), a first box (52) is installed on the side wall of each fixed rod (42), and a first hydraulic rod (51) is installed on the top of the first box (52) and is configured for driving a first toothed plate (53) to move up and down; the first toothed plate (53) is meshed with a first gear (55), and a notch (54) is formed at a middle of a side wall of the first toothed plate (53); a side wall of the wing (41) is fixedly connected to a first rotating shaft (56) fixedly connected to the first gear (55); and a torsional spring (59) sleeves a side wall of the first rotating shaft (56), and two ends of the torsional spring (59) are connected to side walls of the first rotating shaft (56) and the first box (52), respectively.

2. The unmanned aerial vehicle for traffic monitoring according to claim 1, wherein the main body (2) comprises an aircraft body (21), the plurality of legs (1) are symmetrically and obliquely installed on the side walls of the aircraft body (21), and a plurality of aircraft arms (22) are symmetrically installed on the side walls of the main body (2); and a driving motor (23) is installed at one end of each aircraft arm (22), and rotor wings (24) are installed on a top of the driving motor (23).

3. The unmanned aerial vehicle for traffic monitoring according to claim 2, wherein the labeling mechanism (3) comprises a fixed tube (31) provided at a bottom of the aircraft body (21), barrels (311) are symmetrically installed on the side walls of the aircraft body (21), and bottommost ends of the barrels (311) are in communication with an interior of the fixed tube (31) through connecting hoses (33); and a motor (32) for driving a blade (34) to rotate is installed on a top of the fixed tube (31), and a nozzle (312) is installed at a bottom of the fixed tube (31).

4. The unmanned aerial vehicle for traffic monitoring according to claim 3, wherein the labeling mechanism (3) further comprises a fixed block (35), the fixed block (35) and a blocking rod (38) are installed inside the fixed tube (31), a piston (36) is clamped in the fixed block (35), and a spring (37) is installed between the blocking rod (38) and the piston (36); a first magnetic ring (39) is installed on a surface of the piston (36), a second magnetic ring (310) is installed inside the fixed block (35), and the first magnetic ring (39) and the second magnetic ring (310) are adsorbed with each other.

5. The unmanned aerial vehicle for traffic monitoring according to claim 4, wherein interiors of the fixed tube (31) and the fixed block (35) are in a funnel shape, and the blade (34) is in a spiral shape and is rotatably connected to and inside the fixed tube (31).

6. The unmanned aerial vehicle for traffic monitoring according to claim 3, wherein a second driving mechanism (5) comprises a second rotating shaft (57) and a second toothed plate (58), the second rotating shaft (57) is rotatably connected to the bottom of the aircraft body (21), and the fixed tube (31) is fixedly connected to a middle of a side wall of the second rotating shaft (57); a second box (52) is installed to the bottom of the aircraft body (21), the second toothed plate (58) is slidably connected to and inside the second box (52), and the second toothed plate (58) is connected to a second hydraulic rod (51); and the second toothed plate (58) is meshed with the gear (55), and the gear (55) is fixedly connected to the second rotating shaft (57).

7. The unmanned aerial vehicle for traffic monitoring according to claim 6, wherein two ends of the second rotating shaft (57) are fixedly connected to high-definition cameras (25), the high-definition cameras (25) are inclined towards the fixed tube (31), and an infrared camera (26) is installed at the bottom of the aircraft body (21).

8. The unmanned aerial vehicle for traffic monitoring according to claim 2, wherein fixture blocks (45) are symmetrically installed on side walls of the aircraft body (21), a side wall of each fixture block (45) is fixedly connected to an elastic leaf spring (46) with an arc-shaped side wall, and the side wall of the wing (41) is clamped by the leaf spring (46).

9. A monitoring method for an unmanned aerial vehicle for traffic monitoring by employing the unmanned aerial vehicle for traffic monitoring according to claim 1, comprising:
when a high-speed railway is monitored, controlling, by an operating handle of the unmanned aerial vehicle, a communication module inside the main body (1) to connect with a central processing unit inside the main body (1), operating the central processing unit to turn on a flight module to turn on the driving motors (23), the driving motors (23) driving the rotor wings (24) to rotate so that the main body (2) flies, the flight module altering relative rotating speeds among the rotor wings (24) by controlling rotating speeds of the driving motors (23), such that a magnitude of uniaxial propelling force is changed, and a moving trajectory of the main body (2) is controlled; capturing images by the high-definition cameras (25) and the infrared camera (26) at a bottom of the main body (2), and a video storage processing module transmitting the captured images to the operating handle of the unmanned aerial vehicle through the communication module, so that the high-speed railway is convenient for people to monitor;
during the monitoring process, the capturing distance of the infrared camera (26) being long, capturing long-range images, when it is observed that garbage is wrapped around an overhead line system of the high-speed railway, the main body (2) flying to a place where the garbage is wrapped, images of the high-definition cameras (25) being clear, the place where the garbage is wrapped being seen clearly through the high-definition cameras (25), at this time, the main body (2) being located above the garbage, turning on first hydraulic rods (51), the first hydraulic rods (51) driving first toothed plates (53) to move downwards so as to push the wings (41) to rotate downwards, making a distance between two wings (41) closer and closer so that chucks (43) at ends of the wings (41) get close to clamp the garbage, increasing the frictional force through the bumps (44) on the side walls of the chucks (43) to avoid the garbage from sliding off, controlling a flight of the main body (2) to pull off the garbage from a surface of the overhead line system by the main body (2), the wings (41) and the chucks (43), in this process, operating the second hydraulic rod (51) on the side wall of the second rotating shaft (57) to drive the high-definition cameras (25) to rotate so that a process that the garbage is cleared by the chucks (43) is captured by the high-definition cameras (25) clearly, which is convenient for people to operate, and avoids the main body (2) from making direct contact with the overhead line system;
when the high-speed railway takes two minutes to reach the main body (2), transmitting train operation information to the operating handle and the central processing unit of the unmanned aerial vehicle through a high-speed railway operation platform, at this time, operating the main body (2) to fly upwards so that the distance between the main body (2) and the railway is over 10 meters, operating a flight balance module to control operations of the first hydraulic rods (51) on the side walls of the fixed rods (42) to push the wings (41) to open by the first hydraulic rods (51), so as to increase the stability of the main body (2), and at the same time, regulating angles and positions of the wings (41) on both sides of the main body (2) by the flight balance module by controlling the first hydraulic rods (51), so that the stability of the main body (2) is further increased to avoid airflow generated by high-speed railway operation from interfering the flight of the main body (2);
when the overhead line system, the railway, protective screenings and other objects are monitored at short distances, operating the flight balance module to control the operations of the first hydraulic rods (51) to regulate positions of the wings (41), so that the flight stability of the main body (2) is increased; especially, when the overhead line system is monitored by the main body (2), the operation of the aircraft body (21) is affected by a magnetic field generated by the current conveyed by the overhead line system, surfaces of the wings (41) are coated with the absorbing material (47), and the absorbing material (47) reduces the influence of electromagnetic energy around the main body (2) on the main body (2), so that the operational stability of the main body (2) is increased; when a safe failure appears in the monitoring process, spraying out labeling paint by the labeling mechanism (3) at the bottom of the main body (2) and at a failure position on the railway to facilitate workers to observe the failure position, at the same time, transmitting coordinates of the failure position on the railway to the operating handle of the unmanned aerial vehicle by a positioning module to facilitate worker processing; and
when the main body (2) needs to descend, operating the central processing unit to drive the operations of the first hydraulic rods (51) on the side walls of the fixed rods (42), to drive the operations of the first toothed plates (53) to make notches (54) being aligned with respective gears (56), such that the wings (41) are not restrained and move downwards under an effect of torsional springs (59), and the wings (41) and the chucks (43) are obliquely located below the legs (1), when the main body (2) falls to the ground gradually, the chucks (43) make contact with the ground, along with a falling of the main body (2), under an effect of gravity, the chucks (43) and the wings (41) move upwards gradually, the torsional springs (59) rotate strongly, and at the same time, a falling speed of the main body (2) is decreased by the torsional springs (59) so that the main body (2) falls down smoothly.

10. The monitoring method according to claim 9, wherein the main body (2) comprises an aircraft body (21), the plurality of legs (1) are symmetrically and obliquely installed on the side walls of the aircraft body (21), and a plurality of aircraft arms (22) are symmetrically installed on the side walls of the main body (2); and a driving motor (23) is installed at one end of each aircraft arm (22), and rotor wings (24) are installed on a top of the driving motor (23).

11. The monitoring method according to claim 10, wherein the labeling mechanism (3) comprises a fixed tube (31) provided at a bottom of the aircraft body (21), barrels (311) are symmetrically installed on the side walls of the aircraft body (21), and bottommost ends of the barrels (311) are in communication with an interior of the fixed tube (31) through connecting hoses (33); and a motor (32) for driving a blade (34) to rotate is installed on a top of the fixed tube (31), and a nozzle (312) is installed at a bottom of the fixed tube (31).

12. The monitoring method according to claim 11, wherein the labeling mechanism (3) further comprises a fixed block (35), the fixed block (35) and a blocking rod (38) are installed inside the fixed tube (31), a piston (36) is clamped in the fixed block (35), and a spring (37) is installed between the blocking rod (38) and the piston (36); a first magnetic ring (39) is installed on a surface of the piston (36), a second magnetic ring (310) is installed inside the fixed block (35), and the first magnetic ring (39) and the second magnetic ring (310) are adsorbed with each other.

13. The monitoring method according to claim 12, wherein interiors of the fixed tube (31) and the fixed block (35) are in a funnel shape, and the blade (34) is in a spiral shape and is rotatably connected to and inside the fixed tube (31).

14. The monitoring method according to claim 11, wherein a second driving mechanism (5) comprises a second rotating shaft (57) and a second toothed plate (58), the second rotating shaft (57) is rotatably connected to the bottom of the aircraft body (21), and the fixed tube (31) is fixedly connected to a middle of a side wall of the second rotating shaft (57); a second box (52) is installed to the bottom of the aircraft body (21), the second toothed plate (58) is slidably connected to and inside the second box (52), and the second toothed plate (58) is connected to a second hydraulic rod (51); and the second toothed plate (58) is meshed with the gear (55), and the gear (55) is fixedly connected to the second rotating shaft (57).

15. The monitoring method according to claim 14, wherein two ends of the second rotating shaft (57) are fixedly connected to high-definition cameras (25), the high-definition cameras (25) are inclined towards the fixed tube (31), and an infrared camera (26) is installed at the bottom of the aircraft body (21).

16. The monitoring method according to claim 10, wherein fixture blocks (45) are symmetrically installed on side walls of the aircraft body (21), a side wall of each fixture block (45) is fixedly connected to an elastic leaf spring (46) with an arc-shaped side wall, and the side wall of the wing (41) is clamped by the leaf spring (46).
